(19) United States
(12) Patent Application Publication
(10) Pub. No.: US 2013/0191623 A1
(43) Pub. Date: Jul. 25, 2013

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: Takahiro Yamashita, Kawasaki-shi (JP)

(73) Assignee: CANON KABUSHIKI KAISHA, Tokyo (JP)

(21) Appl. No.: 13/741,831

(22) Filed: Jan. 15, 2013

(30) Foreign Application Priority Data
Jan. 20, 2012 (JP) 2012-009546

(51) Int. Cl. G06F 9/44

(52) U.S. Cl. CPC G06F 9/4401
USPC 713/2

(57) ABSTRACT

An information processing apparatus capable of booting in a normal boot mode or a special boot mode includes an input unit configured to input a request for booting the information processing apparatus in the special boot mode in booting the information processing apparatus, and a control unit configured to control the information processing apparatus to be booted in the normal boot mode if the input unit has not input the request, and to control the information processing apparatus to be booted in the special boot mode if the input unit has input the request, wherein, in a case where the information processing apparatus is booted with a predetermined condition satisfied, the control unit controls the information processing apparatus to be booted in the normal boot mode even if the input unit has input the request.

### BACKGROUND OF THE INVENTION

1. Field of the Invention

The present invention relates to boot control (start-up control) for an information processing apparatus.

2. Description of the Related Art

For an information processing apparatus such as an image forming apparatus, a conventional technique for not notifying a user of system reboot or for rebooting a system with a restricted notification is provided. Such technique is used, for example, to transparently refresh contents stored in a memory in rebooting the system without making the user aware of a reboot processing.

The methods of restricting the notification to the user include, for example, methods of not initializing a user interface (UI), not making a sound such as a boot melody, and not initializing or starting a physical device that can make a driving sound after the reboot processing.

Meanwhile, there is a technique in which, when a system is booted and detects an external input, a boot mode or an initialization process of the system is changed depending on the input. Such a technique is used, for example, for the purpose of booting the system or performing a setting for a maintenance mode, in response to a detection of a special key operation in an operation unit, an insertion of a universal serial bus (USB) device, or the like during the boot processing.

Japanese Patent Application Laid-Open No. 2004-230605 discusses a technique for changing the boot processing according to a user setting. More specifically, according to user setting information stored on a nonvolatile area, the system selects whether to implement a normal booting after the power is turned on, or to omit an initialization process for an engine unit and the self-diagnosis of the system to shift to a power-saving mode right after the power-on.

However, in such a case where the system is rebooted without a notification to the user, if the system can detect an external output such as a key operation, an insertion of a USB device, and a packet reception from a network, the system directly shifts to, depending on the input content, a special boot mode such as a maintenance mode after the reboot processing. As a result, the system shifts to a mode in a state not intended by the user.

For example, in a system that shifts to a maintenance mode in response to a detection of insertion of a USB memory storing maintenance data at a booting step, if the reboot is performed without the notification to the user in the state where the USB memory is kept inserted, the system shifts to the maintenance mode, which is not intended by the user.

### SUMMARY OF THE INVENTION

The present invention is directed to an information processing apparatus that prevents itself from shifting to an improper state or a state not intended by a user during a reboot processing thereof without a notification to the user.

According to an aspect of the present invention, an information processing apparatus capable of booting in a normal boot mode or a special boot mode includes an input unit configured to input a request for booting the information processing apparatus in the special boot mode in booting the information processing apparatus, and a control unit configured to control the information processing apparatus to be booted in the normal boot mode if the input unit has not input the request, and to control the information processing apparatus to be booted in the special boot mode if the input unit has input the request, wherein, in a case where the information processing apparatus is booted with a predetermined condition satisfied, the control unit controls the information processing apparatus to be booted in the normal boot mode even if the input unit has input the request.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming apparatus (multifunction peripheral), which is an example of the information processing apparatus according to a first exemplary embodiment of the present invention.

FIG. 2 is a block diagram illustrating an internal configuration of a controller 3 illustrated in FIG. 1 in detail.

FIG. 3 is a flowchart illustrating boot mode selection processing performed at the time of booting of the image forming apparatus according to the first exemplary embodiment.

FIG. 4 is a flowchart illustrating an example of processing of enabling a non-notification boot flag.

FIG. 5 is a graph illustrating state transition of the system of the image forming apparatus by time and power consumption.

FIG. 6 is a flowchart illustrating boot mode selection processing performed at the time of booting of the image forming apparatus according to a second exemplary embodiment of the present invention.

### DESCRIPTION OF THE EMBODIMENTS

Various exemplary embodiments, features, and aspects of the invention will be described in detail below with reference to the drawings.

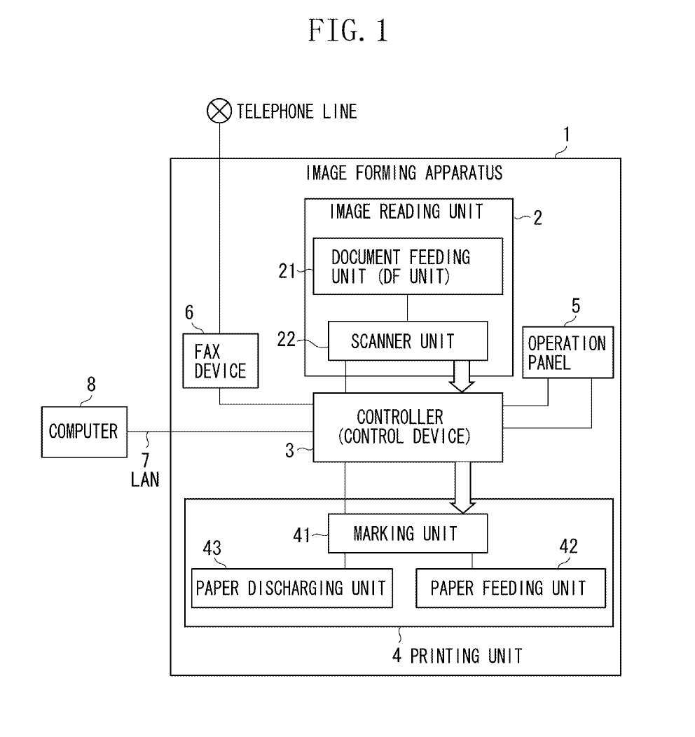

FIG. 1 is a block diagram illustrating a configuration of an image forming apparatus (multifunction peripheral), which is an example of the information processing apparatuses according to the first exemplary embodiment of the present invention. In the exemplary embodiments of the present invention, as an example of the information processing apparatuses, a multifunctional device (multifunction peripheral) having a printer function, a scanner function, a facsimile function, a storage function, and the like is described. It is to be understood that the image forming apparatus according to the exemplary embodiments is not limited to such a configuration, and alternatively, for example, information processing apparatuses such as a personal computer, a game machine, and various types of mobile device can be employed.

As illustrated in FIG. 1, an image forming apparatus 1 includes an image reading unit 2, a printing unit 4, an operation panel 5, a facsimile device 6, and a controller (control device) 3.

The image reading unit 2 optically reads an image from an original document and converts the image into a digital image. The printing unit 4 outputs the digital image onto a recording paper.

The operation panel 5 includes a mechanism for inputting information to the image forming apparatus 1 and a mechanism for outputting system information in the image reading unit 2 to the outside. The facsimile device 6 transmits and receives a digital image via a telephone line, and the like.

The controller 3 is connected to each of the image reading unit 2, the printing unit 4, the operation panel 5, and the facsimile device 6, and issues a instruction to the modules to implement a job.

The image forming apparatus 1 can communicate with a computer 8, which is an external device via a local area network (LAN) 7. The computer 8 can transmit and receive a digital image to and from the image forming apparatus 1, issue a job to the image forming apparatus 1, and transmit an instruction to the image forming apparatus 1.

The image reading unit 2 includes a document feeding unit 21 and a scanner unit 22. The document feeding unit 21 can automatically and sequentially feed a stack of documents disposed on a document feeder (not illustrated). The scanner unit 22 can optically scan a document and converts the document into a digital image. The image data converted by the scanner unit 22 is transmitted to the controller 3.

The printing unit 4 includes a paper feeding unit 42, a marking unit 41, and a paper discharging unit 43. The paper feeding unit 42 can sequentially feed paper one by one from a stack of paper. The marking unit 41 prints image data on the fed paper. The paper discharging unit 43 discharges the printed paper.

The image forming apparatus 1 having such a configuration has various functions, and can perform various jobs. Examples of the functions are described below.

### Copying Function:

The copying function records image data read from the image reading unit 2 in a nonvolatile memory device (hard disk drive 102 described below) on the controller 3, and simultaneously prints the data with the printing unit 4.

### Image Transmission Function:

The image transmission function transmits the image data read from the image reading unit 2 to the computer 8 via the LAN 7.

### Image Storage Function:

The image storage function records the image read from the image reading unit 2 in the nonvolatile memory device (the hard disk drive 102 described below) on the controller 3, and transmits or prints the image as necessary.

### Image Printing Function:

The image printing function analyzes, for example, a page description language sent from the computer 8, and prints the data with the printing unit 4.

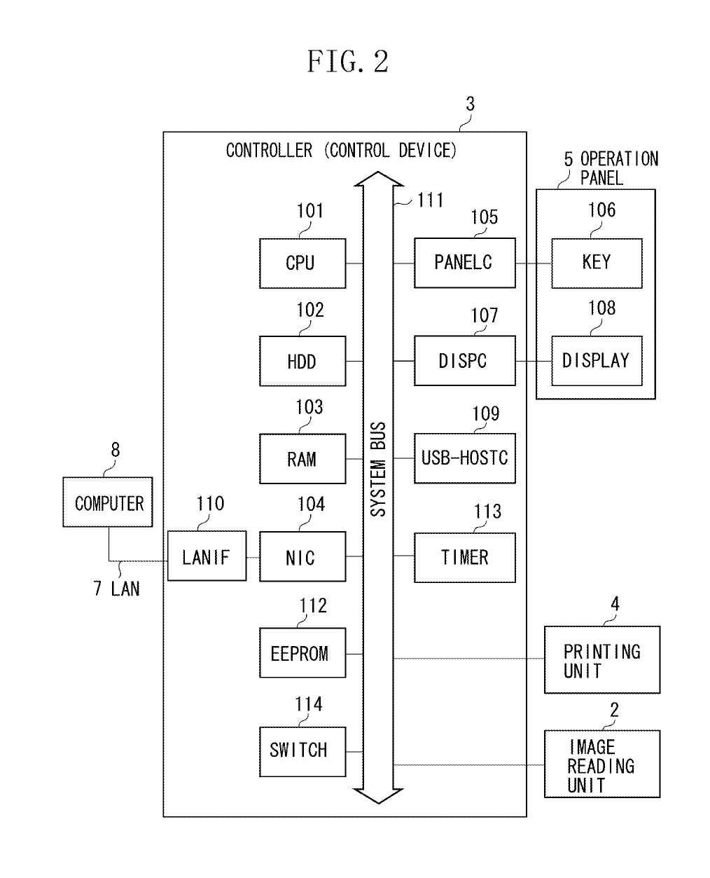

FIG. 2 is a block diagram illustrating an internal configuration of the controller 3 illustrated in FIG. 1 in detail.

As illustrated in FIG. 2, the controller 3 includes a central processing unit (CPU) 101. The CPU 101 performs overall control of the devices connected to a system bus 111 based on an issued instruction set and an input value.

The HDD 102 includes a nonvolatile memory device. In place of the HDD, a solid state drive (SSD), and the like can be provided. The HDD 102 stores data such as a boot loader for selecting an operating system, an operating system that is basic software on the system, firmware for implementing and controlling the individual functions, and a file system for efficiently managing files.

A random access memory (RAM) 103 includes a volatile memory, and functions as a main memory or a work area for the CPU 101.

A network interface card (NIC) 104 connects a LAN cable to a LAN interface (LANIF) 110 to bi-directionally exchange data with another network device, the computer 8, or the like via the LAN 7.

The operation panel 5 includes a touch panel (not illustrated) for inputting an instruction, an operation key (KEY) 106, and a display unit (DISPLAY) 108 for displaying system information. An external input controller (PANELC) 105 detects and controls an instruction input from the touch panel in the operation panel 5 or the operation key 106. A display controller (DISPC) 107 controls display of the display unit 108.

A USB host controller (USB-HOSTC) 109 can be connected to a device having a USB interface such as a large-capacity storage device (USB memory, etc.) and an IC card reader.

An electrically erasable and programmable read only memory (EEPROM) 112 includes a rewritable low-capacity nonvolatile memory device. The EEPROM 112 stores, for example, setting information of the image forming apparatus.

A timer (TIMER) 113 includes a secondary battery, and always measures the time elapsed from reference time, and also measures elapsed time in accordance with an instruction from the CPU 101.

A switch (SWITCH) 114 can issue a power control instruction to the CPU 101. In accordance with the power control instruction issued by the switch 114, the CPU 101 performs, for example, boot processing, shutdown processing, and power state transition processing to a power-saving state described below.

In addition to the normal state in which the electric power is supplied to each unit, the state of the image forming apparatus 1 can be shifted to a power-saving state in which power consumption is relatively low. The shift is described in detail below.

In response to the reception of a request for shifting to the power-saving state, the CPU 101 reduces the power supply provided to each unit other than the RAM 103, the operation panel 5, and the switch 114, shifts to the power-saving mode in which the power consumption is saved, and sets the CPU 101 itself to a state where only a request for shifting to the normal state can be received. Note that to enable the image forming apparatus 1 to shift to the normal state in response to reception of a print request from the LAN 7, the power supply to the NIC 104 and the LANIF 110, which are external IFs, may continue to be provided. In a case the CPU 101 receives the request for shifting to the normal state, the CPU 101 supplies electric power to the units where the power supply has been reduced, performs initialization processing of the units, and thereby the power-saving state shifts from the power-saving state to the normal state. The request for shifting to the power-saving state and the request for shifting to the normal state can be issued, for example, through an operation on the switch 114 or an input from the operation key 106.

Although not illustrated in FIGS. 1 and 2, the image forming apparatus 1 includes a power supply unit (not illustrated), and supplies electric power from the power supply unit to the image forming apparatus 1.

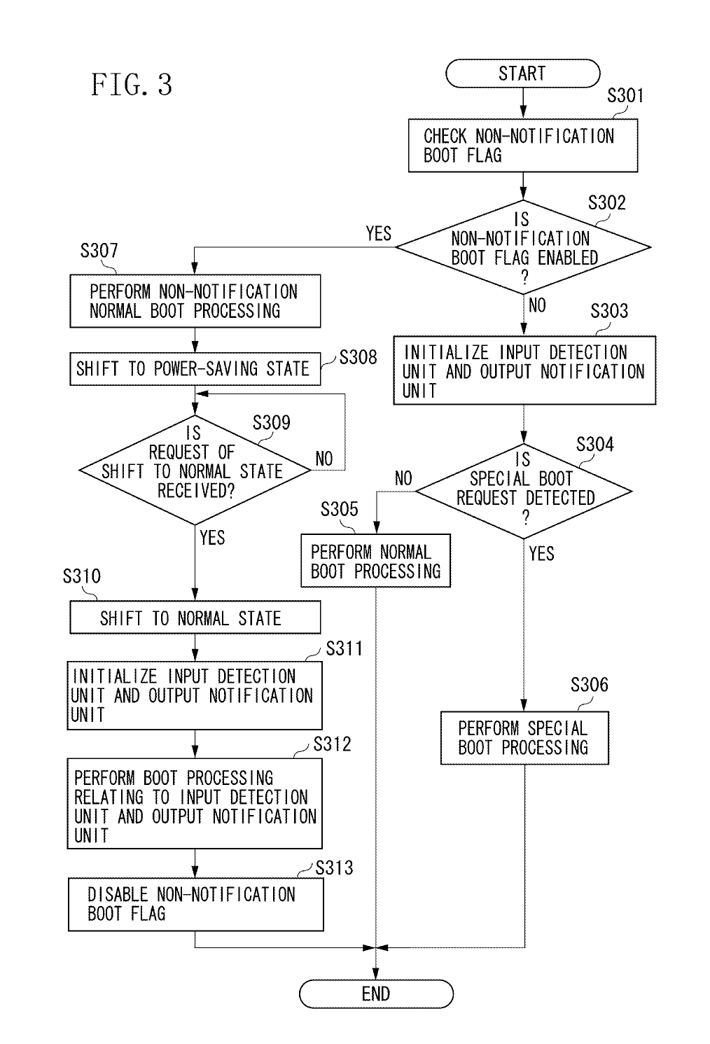

With reference to FIG. 3, the boot mode selection processing performed at the time of booting of the image forming apparatus 1 according to the first exemplary embodiment is described.

FIG. 3 is a flowchart illustrating the boot mode selection processing performed at the time of booting of the information processing apparatus 1 according to the first exemplary embodiment. The processing according to the flowchart is implemented by the CPU 101, which loads a computer-readable program stored in the HDD 102 into the RAM 103.

In the flowchart, in a case where the system is booted without a notification to the user, a special boot determination is not performed. Consequently, the shift to a special boot mode not intended by the user can be prevented. Hereinafter, selection from three different boot modes of a normal boot mode (with a notification to the user), a normal boot mode (without a notification to the user), and a special boot mode is described. Depending on the selected boot mode, an operating system, firmware, and a file system to be used are selected, and consequently, the boot mode selection processing is to be performed at an initial stage in the boot processing.

First, in step S301, the CPU 101 checks a non-notification boot flag. In this step, the CPU 101 reads a non-notification boot flag at a specific address in a predetermined storage area. The storage area can include the volatile memory (the RAM 103) or the nonvolatile memory (the HDD 102 or the EEPROM 112).

In step S302, the CPU 101 determines whether the non-notification boot flag read in step S301 is enabled. In this step, the CPU 101 compares the non-notification boot flag read in step S301 with a predetermined value. If the non-notification boot flag corresponds to the predetermined value, the CPU 101 determines that the non-notification boot flag is enabled, and if the non-notification boot flag does not correspond to the predetermined value, the CPU 101 determines that the flag is disabled.

In step S302, if the CPU 101 determines that the non-notification boot flag is enabled (YES in step S302), the process proceeds to step S307. In step S307, the CPU 101 performs the non-notification boot processing, and the like.

In step S302, if the CPU 101 determines that the non-notification boot flag is disabled (invalid) (NO in step S302), the process proceeds to step S303. In step S303, the CPU 101 performs the normal boot processing or the special boot determination processing.

The flow (the process performed when NO in step S302) for performing the normal boot processing or the special boot processing is described.

In step S303, the CPU 101 initializes an input detection unit and an output notification unit. The input detection unit includes the external input controller 105, the operation key 106, the USB host controller 109, and the image reading unit 2. The output notification unit includes the display controller 107, the display unit 108, and the printing unit 4. In step S303, the CPU 101 performs a register setting to each of the input detection unit and the output notification unit. The process enables each of the input detection unit and the output notification unit to function as a hardware device. Consequently, the CPU 101 can, for example, display a bitmap image indicating steps in the boot processing on the display unit 108, and detect a pressing operation on the operation key 106. In other words, the CPU 101 can issue a notification to the outside with the output notification unit, and detect an input of a special boot request with the input detection unit.

In step S304, the CPU 101 checks whether a special boot request is issued to the input detection unit. Depending on whether the special boot request is issued or not, the CPU 101 selects the normal boot mode or the special boot mode. The special boot request is generated when the input detection unit detects a specific operation by the user, and the request is notified to the CPU 101. The specific operation includes, for example, a pressing operation on the operation key in a predetermined order, and an insertion of a USB memory storing maintenance data into the USB host controller 109. The CPU 101 waits for the above-described special boot request from the operation key 106 or the USB host controller 109 for a predetermined time period. If the special boot request is issued within the time period, the CPU 101 determines that the special boot request is detected. If the special boot request is not issued within the time period, the CPU 101 determines that the special boot request is not detected.

In step S304, if the CPU 101 determines that the special boot request is detected (YES in step S304), the process proceeds to step S306.

In step S304, if the CPU 101 determines that the special boot request is not detected (NO in step S304), the process proceeds to step S305.

In step S305, the CPU 101 performs the normal boot processing. In this step, the CPU 101 loads the operating system and the firmware in the HDD 102 into the RAM 103. Further, the CPU 101 performs the boot processing according to the firmware in the RAM 103 and the contents of the setting file stored in the file system in the HDD 102. The normal boot processing is performed as described above.

In step S306, the CPU 101 performs the special boot processing. As an example of the special boot, a maintenance mode for restoring or updating the data in the HDD 102 is described. After the detection of the insertion of the USB memory in step S304, then in this step, the CPU 101 loads the operating system and the firmware in the USB memory into the RAM 103. Further, the CPU 101 overwrites the operating system, the firmware, and the file system in the HDD 102 in accordance with the firmware in the RAM 103 and the contents of the setting file stored in the file system in the USB memory. The special boot can be performed not only in the maintenance mode, but in any mode (special operation mode) dedicated to a special operation. The special boot processing is performed as described above.

The flow (the process performed when YES in step S302) for performing the non-notification boot processing is described.

First, in step S307, the CPU 101 performs the non-notification boot processing. In this processing, different from the above-described normal boot processing and the special boot processing performed after step S303, the CPU 101 does not perform the notification to the outside with the output notification unit. At this point, the input detection unit has not been initialized, and is not be able to detect an input of a special boot request with the input detection unit. Consequently, at the time of the boot processing, it is not necessary to consider the input of the special boot processing.

Further, in the non-notification normal boot processing in step S307, the boot processing relating to the input detection unit and the output notification unit, which is performed in the normal boot processing in step S305, is not performed since the input detection unit and the output notification unit have not been initialized.

The information processing apparatus 1 according to the exemplary embodiment, after the system booting by the non-notification normal boot processing in step S307, shifts to the power-saving state in step S308 described below. However, until the information processing apparatus 1 becomes able to shift to the power-saving state after the system booting, the notification to the outside with the output notification unit is not performed, and the initialization processing of the input detection unit is not performed. Since the initialization processing is not performed, no special boot request is detected. This can prevent the special boot request from being detected and the information processing apparatus 1 from being booted in the special operation mode, when performing the non-notification normal boot processing.

In step S308, the CPU 101 shifts the system to the power-saving state. In the exemplary embodiment, it is assumed that the non-notification boot processing is performed in a case where the user does not frequently use the information processing apparatus 1, so that the processing can quickly shift to the power-saving state by this step to reduce unnecessary power consumption. The process of shifting to the power-saving state in step S308 includes a minimum process enabling the use of part of the operation panel 5 such that a request for shifting to the normal state can be received with a pressing operation on the operation key 106.

In step S309, the CPU 101 waits for a request for shifting the system to the normal state. In this step, if the CPU 101 receives a request for shifting to the normal state with a pressing operation on the operation key 106, or the like (YES in step S309), then in step S310, the CPU 101 shifts the system to the normal state, and the process proceeds to step S311. If the CPU 101 does not receive the request for shifting to the normal state (NO in step S309), the CPU 101 waits for the request of shifting.

In step S311, similarly to the processing in step S303, the CPU 101 initializes the input detection unit and the output notification unit.

In step S312, the CPU 101 performs boot processing relating to the input detection unit and the output notification unit. The boot processing relating to the input detection unit and the output notification unit includes, specifically, a calibration process of a touch panel on the operation panel 5, and an adjustment operation in the printing unit 4 and the image reading unit 2. In the above-described normal boot processing in step S305, the above-described processing in step S307 and step S312 is performed.

In step S313, the CPU 101 writes the data in a specific address in the storage area accessed in step S301, and disables the non-notification boot flag. The processing in step S313 can be performed at any timing after the determination of YES in step S302.

In response to the completion of the processing in step S313, S305, or S306, the CPU 101 ends the processing according to the flowchart.

As described above, in the information processing apparatus 1 according to the exemplary embodiment, in the case where the system is booted by the non-notification normal boot processing, the notification to the outside with the output notification unit is not performed, and further, the initialization processing of the input detection unit is not performed until the information processing apparatus 1 becomes able to shift to the power-saving state after the system booting. Since the initialization processing is not performed, no special boot request is detected. In returning to the normal state from the power-saving state, the information processing apparatus 1 according to the exemplary embodiment performs the processing (initialization processing) for enabling the use of the input detection unit.

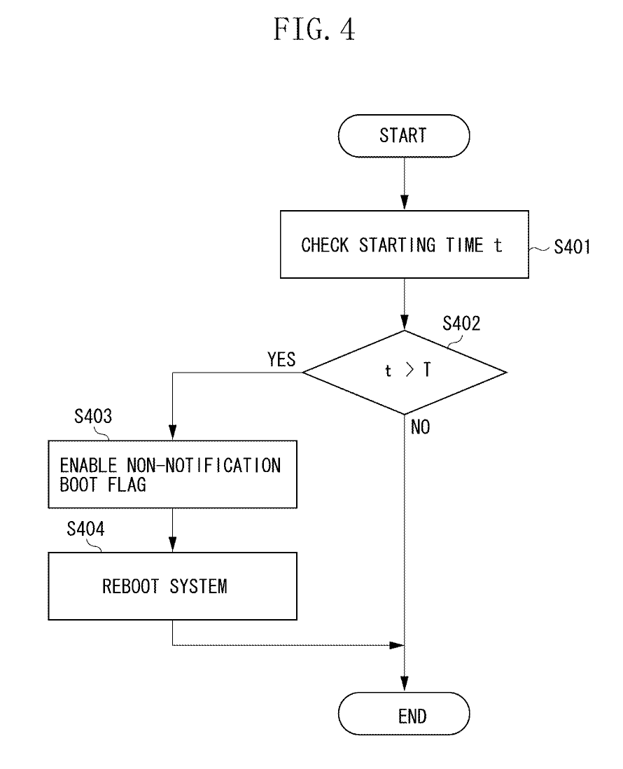

Hereinafter, with reference to FIG. 4, the processing of enabling the non-notification boot flag (the flag determined in steps S301 and 302 in FIG. 3) is described.

FIG. 4 is a flowchart illustrating an example of the processing of enabling the non-notification boot flag. The processing according to the flowchart is implemented by the CPU 101, which loads a computer-readable program stored in the HDD 102 into the RAM 103. In the flowchart, for example, at a specified time Tx on a weekday, the CPU 101 determines whether the system has not been rebooted for a certain period of time, and transparently reboots the system to prevent a decrease in performance due to fragmented data in the RAM 103, without making the user aware of the reboot processing.

In the reboot processing according to the flowchart, the non-notification boot flag is enabled such that, as illustrated in FIG. 3, the determination of shift to the special boot mode is not performed (YES in step S302 in FIG. 3, and the process in step S304 is not performed). This can prevent, when the user operates the system next time, the system from being kept in the standby state in the special boot mode. In the exemplary embodiment, for example, in a case where a timer 113 reaches the predetermined specified time Tx on a weekday, the CPU 101 starts the processing after step S401.

In step S401, the CPU 101 acquires a starting time t indicating an elapsing time from a previous power activation, using the timer 113. Every time the power is turned on, the CPU 101 stores the time and date at a specific address in a predetermined storage area in a nonvolatile memory (the HDD 102 or the EEPROM 112).

In step S402, the CPU 101 compares the length of the starting time t acquired in step S401 to the length of a predetermined constant T. The constant T is stored at a specific address in a predetermined storage area in a nonvolatile memory (the HDD 102 or the EEPROM 112).

If the CPU 101 determines that the length of the starting time t is shorter than the constant T (t≦T) (NO in step S402), the CPU 101 ends the processing according to the flowchart.

If the CPU 101 determines that the length of the starting time t is longer than the constant T (t>T) (YES in step S402), the CPU 101 determines that the system reboot has not been performed for the predetermined time period. Then, the process proceeds to step S403, and the CPU 101 performs processing of transparently rebooting the system without a notification to the user.

In step S403, the CPU 101 enables the non-notification boot flag at the specific address in the predetermined storage area in the nonvolatile memory (the HDD 102 or the EEPROM 112). In step S404, the CPU 101 reboots the system. By the processing, the system is rebooted in the state where the non-notification boot flag is enabled, and consequently, the start-up processing without a notification illustrated in FIG. 3 (the processes from step S307 to step S313 after YES in step S302) is performed. In other words, by the processing in steps S403 and S404, the non-notification boot request of the system is performed.

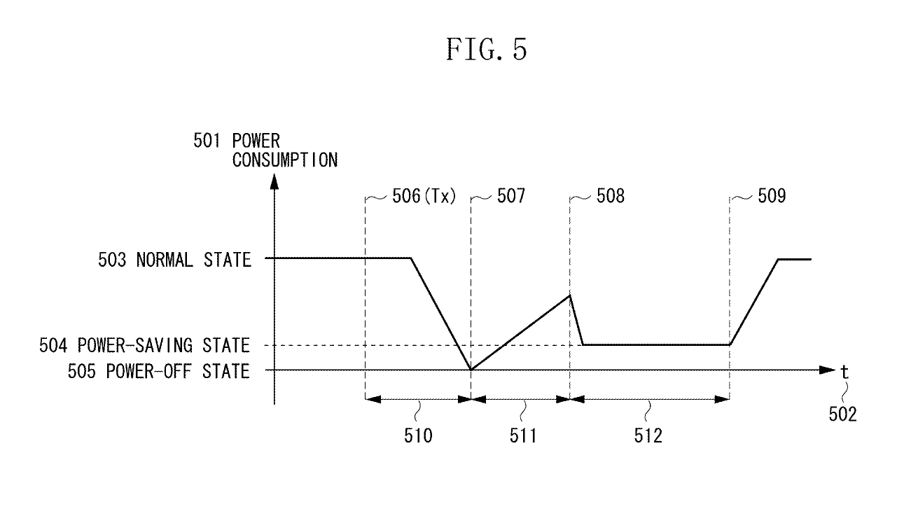

With reference to FIG. 5, the relationship between the system state transition of the information processing apparatus 1 and the power consumption is described.

FIG. 5 is a graph illustrating the state transition of the system of the information processing apparatus 1 with time and power consumption. FIG. 5 illustrates the system from receiving a non-notification boot request, performing the non-notification reboot processing, to shifting to the power-saving state. In FIG. 5, an example in which the power consumption is to be “0” before and after the reboot processing is illustrated. In another system, for example, in a case where only a reset signal is issued at the reboot processing, the power consumption may not be “0” before and after the reboot processing. The exemplary embodiment of the present invention can also be applied to such a case.

In FIG. 5, the vertical axis 501 shows values of power consumed by the information processing apparatus 1, and the horizontal axis shows time.

In the vertical axis 501, three power consumption states of the system are defined for convenience. The three power consumption states of the system are a normal state 503, a power-saving state 504, and a power-off state 505, and the amounts of power consumed by the system become smaller in this order: the power consumption in the normal state 503 > the power consumption in the power-saving state 504 > the power consumption in the power-off state 505.

In the horizontal axis 502 four times are defined for convenience, as described below.

A time 506 corresponds to the specified time Tx described in FIG. 4. At the time 506, the CPU 101 starts the processing in FIG. 4.

A time 507 indicates the time when the end processing of the system is completed. At the time 507, the content of the RAM 103 is refreshed.

A time 508indicates the time when the boot processing (the non-notification normal boot processing) is completed after the system is started and the system shifts to the state where the system is able to shift to the power-saving state. The time 508 corresponds to the time when the processing in step S307 in FIG. 3 is completed.

A time 509 indicates the time when the system receives a request for shifting from the power-saving state to the normal state. The time 509 corresponds to the time when the processing proceeds to YES in step S309 in FIG. 3.

With the above-described four times of 506, 507, 508, and 509, the three time periods described below is defined.

In a time period 510, the system performs the reboot processing illustrated in FIG. 4. From the unit in which the processing is completed, the CPU 101 reduces the power supply, and starts the processing of checking the non-notification boot flag.

In the time period 511, the system checks the non-notification boot flag, and performs the non-notification reboot processing. After the completion of the processing, the system shifts to the power-saving state. In other words, in the time period 511, the processing in steps S301, S302, S307, and S308 is performed.

In the time period 512, the system waits for a request for shifting to the normal state. That is, the time period 512 corresponds to the time period of NO in step S309 in FIG. 3.

As described above, according to the exemplary embodiment, when the information processing apparatus is rebooted without a notification to the user (in the non-notification normal boot processing), the image forming apparatus can prevent itself from shifting to an improper state or a state not intended by the user (a special operation mode such as a maintenance mode).

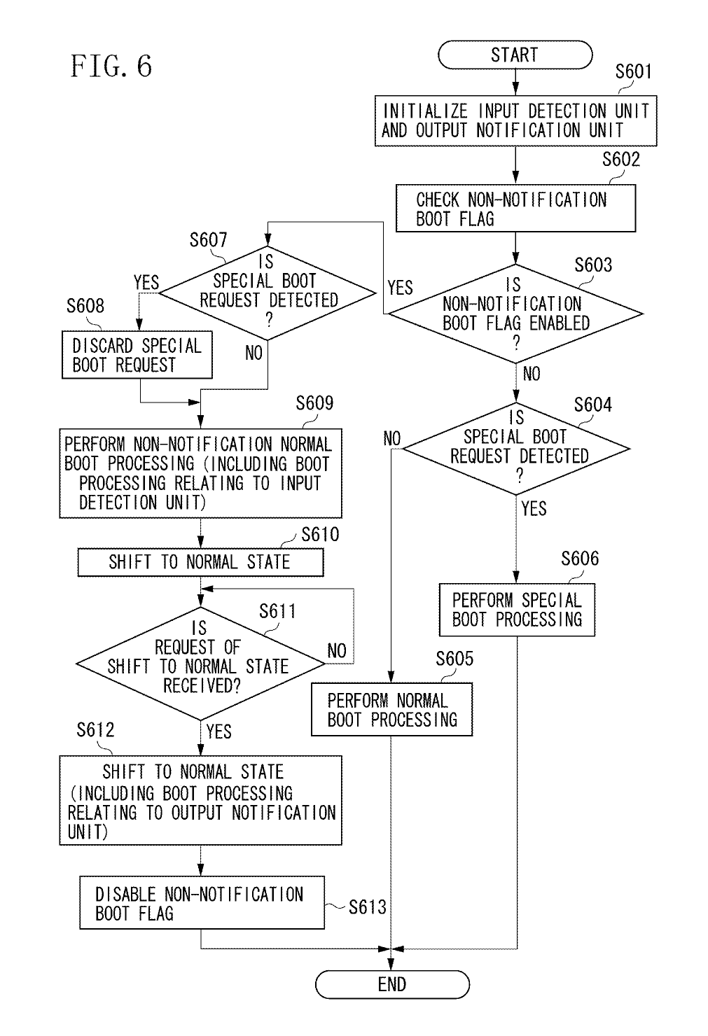

The second exemplary embodiment of the present invention is similar to the first exemplary embodiment in many respects, and different in that the processing according to the flowchart in FIG. 6 is used instead of the processing according to the flowchart in FIG. 3. In the second exemplary embodiment, in the non-notification boot processing, the image forming apparatus moves up the execution of the processing that cannot be performed if the input detection unit is not initialized. This can improve the user's convenience in the non-notification boot processing.

With reference to FIG. 6, the boot mode selection processing performed at the time of booting of the image forming apparatus 1 according to the second exemplary embodiment is described.

FIG. 6 is a flowchart illustrating the boot mode selection processing performed at the time of booting of the image forming apparatus 1 according to the second exemplary embodiment. The processing according to the flowchart is implemented by the CPU 101, which loads, a computer-readable program stored in the HDD 102 into the RAM 103. The flowchart in FIG. 6 is different from that in FIG. 3 in that the initialization of the input detection unit is performed regardless of notification/non-notification of the boot processing, and a special boot request is discarded at the non-notification boot processing. Such a process in the boot processing according to the flowchart can move up the process that cannot be performed if the input detection unit is not initialized, thereby being useful in a system that takes time for such boot processing.

Hereinafter, only processes in FIG. 6 different from those in FIG. 3 will be described.

In step S601, the CPU 101 initializes the input detection unit and the output notification unit regardless of notification/non-notification of the boot processing. The processing in step S601 is similar to that in step S303 in FIG. 3.

Next, the CPU 101 performs the processes in steps S602 and S603. The processes in steps S602 and S603 are similar to those in steps S301 and S302 in FIG. 3, and the descriptions of the processes are omitted.

In step S603, if the CPU 101 determines that the non-notification boot flag is enabled (YES in step S603), the process proceeds to step S607. In step S607, the CPU 101 performs the non-notification normal boot processing and other processes.

In step S603, if the CPU 101 determines that the non-notification boot flag is not enabled (disabled) (NO in step S603), the process proceeds to step S604. In step S604, the CPU 101 performs the determination of a normal boot processing or a special boot processing, and the like.

First, the flow (the process performed when No in step S603) for performing the normal boot processing or the special boot processing is described. The processes in steps S604 to S606 are similar to those in steps S304 to S306 in FIG. 3, and the descriptions of the processes are omitted.

Next, the flow (the process performed when YES in step S603) for performing the non-notification boot processing, which is a feature of the exemplary embodiment of the present invention is described.

In step S607, similarly to the case of the notification boot processing (NO in step S603), the CPU 101 checks whether a special boot request is issued to the input detection unit.

In step S607, if the CPU 101 determines that the special boot request is detected (YES in step S607), the process proceeds to step S608.

In step S608, the CPU 101 discards the special boot request, and the process proceeds to step S609. The discarding process in step S608 can prevent the image forming apparatus 1 from being started in the special operation mode even if the input of the special boot request is detected in performing the non-notification normal boot processing.

In step S607, if the CPU 101 determines that the special boot request is not detected (NO in step S607), the process directly proceeds to step S609.

In step S609, the CPU 101 performs the non-notification normal boot processing. In the non-notification normal boot processing in step S609, similarly to the process in step S307 in FIG. 3, the CPU 101 does not perform a notification to the outside using the output notification unit. Further, in the non-notification normal boot processing in step S307, the boot processing relating to the output notification unit performed in the normal boot processing in step S305 is not also performed. In the non-notification normal boot processing in step S609, however, different from the non-notification boot processing in step S307 in FIG. 3, the boot processing relating to the input detection unit (part of the process in step S312 in FIG. 3) is also performed. The process enables the image forming apparatus 1 to complete the boot processing before shifting to the power-saving state, thereby improving the user's convenience. In other words, after the image forming apparatus 1 shifting to the normal state, the user does not need to wait for the boot processing relating to the input detection unit, and can enjoy convenience.

The image forming apparatus 1 according to the exemplary embodiment, after the system booting in the non-notification normal boot processing in step S609, shifts to the power-saving state (step S610 described below). After the system booting, however, until entering the state where the information processing apparatus 1 is able to shift to the power-saving state, the notification to the outside with the output notification unit is not performed, and the special boot request of the input detection unit is discarded.

Subsequently, the CPU 101 performs the processes in steps S610 and S611. The processes in steps S610 and S611 are similar to those in steps S309 and S310 in FIG. 3, and the descriptions of the processes are omitted.

In step S612, the CPU 101 shifts the system to the normal state. In the shift process to the normal state in step S612, different from the shift process to the normal state in step S310 in FIG. 3, the boot processing relating to the output notification unit (part of the process in step S312 in FIG. 3) is also performed.

Subsequently, the CPU 101 performs the process in step S613. The process in step S613 is similar to that in step S313 in FIG. 3, and the description of the process is omitted.

In the image forming apparatus 1 according to the exemplary embodiment, the above-described process in the non-notification boot processing can move up the process that cannot be performed if the input detection unit is not initialized. This can reduce the waiting time from the power-saving state after the non-notification boot processing to the normal state to make the image forming apparatus 1 operational. As a result, in addition to the effect according to the first exemplary embodiment, the user's convenience can also be increased in the non-notification boot processing.

In the conventional techniques, even if the user do not notice that the system of the image forming apparatus 1 is being rebooted, input to the system is allowed, and thus the system can shift to an improper state due to the input detection of a special boot request. In the exemplary embodiments of the present invention, when the system is rebooted while the output (notification) to the user is restricted, the control of the input detection unit after the reboot processing is changed or initialization thereof is delayed (restricted). This can prevent the system from shifting to an improper state (the state transition by the input of special boot request) due to the detection of the input of the special boot request. Thus, the problem in the conventional techniques can be solved.

In the above-described first and second exemplary embodiments, the examples employing image forming apparatus is described. However, in the exemplary embodiments of the present invention, instead of the image forming apparatus, any information processing apparatus including the input detection unit and the output notification unit, and operable in the power-saving state can be employed.

While the exemplary embodiments have been described, the present invention can be implemented, for example, as a system, an apparatus, a method, a program, or a storage medium storing the program. Specifically, the present invention can be applied to a system including a plurality of devices or an apparatus consists of a single device.

The present invention includes all configurations implemented by combining the above-described exemplary embodiments.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-009546 filed Jan. 20, 2012, which is hereby incorporated by reference herein in its entirety.

What is claimed is:

1. An information processing apparatus capable of booting in a normal boot mode or a special boot mode, the information processing apparatus comprising:
an input unit configured to input a request for booting the information processing apparatus in the special boot mode in booting the information processing apparatus; and
a control unit configured to control the information processing apparatus to be booted in the normal boot mode if the input unit has not input the request, and to control the information processing apparatus to be booted in the special boot mode if the input unit has input the request,
wherein, in a case where the information processing apparatus is booted with a predetermined condition satisfied, the control unit controls the information processing apparatus to be booted in the normal boot mode even if the input unit has input the request.

2. The information processing apparatus according to claim 1, wherein, in a case where the information processing apparatus is booted with the predetermined condition satisfied, the control unit ignores the request even if the input unit has input the request.

3. An information processing apparatus capable of booting in a normal boot mode or a special boot mode, the information processing apparatus comprising:
an input unit configured to input an request for booting the information processing apparatus in the special boot mode in booting the information processing apparatus; and
a control unit configured to control the information processing apparatus to be booted in the normal boot mode if the input unit has not input the request, and to control the information processing apparatus to be booted in the special boot mode if the input unit has input the request,
wherein, in a case where the information processing apparatus is booted with a predetermined condition satisfied, the control unit controls the input unit not to input the request until a boot process of the information processing apparatus is completed.

4. The information processing apparatus according to claim 3, wherein, in a case where the information processing apparatus is booted with the predetermined condition satisfied, the control unit does not supply electricity to the input unit until the boot process of the information processing apparatus is completed.

5. The information processing apparatus according to claim 3, wherein, in a case where the information processing apparatus is booted with the predetermined condition satisfied, the control unit does not initialize the input unit until the boot process of the information processing apparatus is completed.

6. A method of controlling an information processing apparatus capable of booting in a normal boot mode or a special boot mode, the method comprising:
inputting a request for booting the information processing apparatus in the special boot mode in booting the information processing apparatus;
controlling the information processing apparatus to be booted in the normal boot mode if the request has not been input, and controlling the information processing apparatus to be booted in the special boot mode if the request has been input; and
controlling, in a case where the information processing apparatus is booted with a predetermined condition satisfied, the information processing apparatus to be booted in the normal boot mode even if the request has been input.

7. A method of controlling an information processing apparatus capable of booting in a normal boot mode or a special boot mode, the method comprising:
inputting an request for booting the information processing apparatus in the special boot mode in booting the information processing apparatus;
controlling the information processing apparatus to be booted in the normal boot mode if the request has not been input, and controlling the information processing apparatus to be booted in the special boot mode if the request has been input; and
controlling, in a case where the information processing apparatus is booted with a predetermined condition satisfied, the request not to be input until a boot process of the information processing apparatus is completed.

8. A computer-readable storage medium storing a program that causes an information processing apparatus capable of booting in a normal boot mode or a special boot mode to perform a method, the method comprising:
inputting a request for booting the information processing apparatus in the special boot mode in booting the information processing apparatus;
controlling the information processing apparatus to be booted in the normal boot mode if the request has not been input, and controlling the information processing apparatus to be booted in the special boot mode if the request has been input; and
controlling, in a case where the information processing apparatus is booted with a predetermined condition satisfied, the information processing apparatus to be booted in the normal boot mode even if the request has been input.

9. A computer-readable storage medium storing a program that causes an information processing apparatus capable of booting in a normal boot mode or a special boot mode to perform a method, the method comprising:
inputting an request for booting the information processing apparatus in the special boot mode in booting the information processing apparatus;
controlling the information processing apparatus to be booted in the normal boot mode if the request has not been input, and controlling the information processing apparatus to be booted in the special boot mode if the request has been input; and
controlling, in a case where the information processing apparatus is booted with a predetermined condition satisfied, the request not to be input until a boot process of the information processing apparatus is completed.
